(19) United States
(12) Patent Application Publication
(10) Pub. No.: US 2025/0013162 A1
(43) Pub. Date: Jan. 9, 2025

(54) TONER, TONER ACCOMMODATING UNIT, IMAGE FORMING APPARATUS, IMAGE FORMING METHOD, METHOD OF PRODUCING PRINTED MATTER, AND METHOD OF MANUFACTURING TONER

(71) Applicants: Ayaka Mori, Shizuoka (JP); Yoshitaka Yamauchi, Shizuoka (JP); hisashi nakajima, Shizuoka (JP); Kohtaroh Ogino, Shizuoka (JP); Shimpei Miyata, Shizuoka (JP)

(72) Inventors: Ayaka Mori, Shizuoka (JP); Yoshitaka Yamauchi, Shizuoka (JP); hisashi nakajima, Shizuoka (JP); Kohtaroh Ogino, Shizuoka (JP); Shimpei Miyata, Shizuoka (JP)

(73) Assignee: Ricoh Company, Ltd., Tokyo (JP)

(21) Appl. No.: 18/760,079

(22) Filed: Jul. 1, 2024

(30) Foreign Application Priority Data
Jul. 4, 2023 (JP) 2023-109908

(51) Int. Cl. G03G 9/087; G03G 9/08

(52) U.S. Cl. CPC G03G 9/08755; G03G 9/0802; G03G 9/0821; G03G 9/08706; G03G 9/08782; G03G 9/08795; G03G 9/08797

(57) ABSTRACT

A toner contains a polyester resin and a styrene resin, wherein the peak ratio (R1/W1) is between 1.00 and 2.00, where R1 represents the maximum peak height in a range of 710 cm⁻¹ to 690 cm⁻¹ of a Fourier Transform Infrared Spectroscopy (FT-IR) spectrum of the toner measured by Attenuated Total Reflection (ATR) method, and W1 represents the maximum peak height in a range of 789 cm⁻¹ to 852 cm⁻¹ of the FT-IR spectrum of the toner measured by ATR method, and the peak ratio (R2/W2) is between 0.80 and 1.20, where R2 represents the maximum peak height in a range of 710 cm⁻¹ to 690 cm⁻¹ of an FT-IR spectrum of the toner measured by KBr tablet method, and W2 represents the maximum peak height in a range of 789 cm⁻¹ to 852 cm⁻¹ of the FT-IR spectrum of the toner measured by KBr tablet method.

### CROSS-REFERENCE TO RELATED APPLICATIONS

This patent application is based on and claims priority pursuant to 35 U.S.C. § 119 to Japanese Patent Application No. 2023-109908, filed on Jul. 4, 2023, in the Japan Patent Office, the entire disclosure of which is hereby incorporated by reference herein.

### BACKGROUND

### Technical Field

The present invention is related to a toner, a toner accommodating unit, an image forming apparatus, an image forming method, a method of producing printed matter, and a method of manufacturing toner.

### Description of the Related Art

Traditionally, electrophotographic apparatuses and electrostatic recording apparatuses visualize latent electrical or magnetic images using toner for developing latent electrostatic images (referred to as toner in the present invention). For example, in the electrophotography, latent electrostatic images are formed on an image bearer such as a photoconductor and developed with toner to form toner images. The toner image is transferred to a recording medium, typically paper, and thereafter fixed thereon by methods such as heating.

In recent years, there has been a demand for toner fixable at lower temperatures to reduce the energy required for fixing, thereby achieving energy savings. Moreover, coupled with the diversification in usage of image forming apparatuses, these apparatuses are required to achieve higher performance while producing higher quality images. As a method of enhancing the low temperature fixability of toner, techniques using a combination of amorphous polyester resin and crystalline polyester resin are known.

### SUMMARY

According to embodiments of the present invention, a toner is provided which contains a polyester resin and a styrene resin, wherein the peak ratio (R1/W1) is between 1.00 and 2.00, where R1 represents the maximum peak height in a range of 710 cm⁻¹ to 690 cm⁻¹ of a Fourier Transform Infrared Spectroscopy (FT-IR) spectrum of the toner measured by Attenuated Total Reflection (ATR) method, and W1 represents the maximum peak height in a range of 789 cm⁻¹ to 852 cm⁻¹ of the FT-IR spectrum of the toner measured by ATR method, and the peak ratio (R2/W2) is between 0.80 and 1.20, where R2 represents the maximum peak height in a range of 710 cm⁻¹ to 690 cm⁻¹ of an FT-IR spectrum of the toner measured by KBr tablet method and W2 represents the maximum peak height in a range of 789 cm⁻¹ to 852 cm⁻¹ of the FT-IR spectrum of the toner measured by KBr tablet method.

As another aspect of embodiments of the present invention, a toner accommodating unit is provided which contains the toner mentioned above.

As another aspect of embodiments of the present invention, an image forming apparatus is provided which includes a latent electrostatic image bearer, a latent electrostatic image forming device to form a latent electrostatic image on the latent electrostatic image bearer, a developing device to develop the latent electrostatic image on the latent electrostatic image bearer with the toner mentioned above to form a toner image, a transfer device to transfer the toner image onto a surface of a recording medium, and a fixing device to fix the toner image on the surface of the recording medium.

As another aspect of embodiments of the present invention, an image forming method is provided which includes forming a latent electrostatic image on a latent electrostatic image bearer, developing the latent electrostatic image formed on the latent electrostatic image bearer with the toner mentioned above to form a toner image, transferring the toner image formed on the latent electrostatic image bearer to a surface of a recording medium, and fixing the toner image on the surface of the recording medium.

As another aspect of embodiments of the present invention, a method of producing printed matter is provided which includes forming printed matter on a recording medium using an image forming apparatus including a latent electrostatic image bearer, a latent electrostatic image forming device to form a latent electrostatic image on the latent electrostatic image bearer, a developing device to develop the latent electrostatic image on the latent electrostatic image bearer with the toner mentioned above to form a toner image, a transfer device to transfer the toner image onto a surface of the recording medium, and a fixing device to fix the toner image on the surface of the recording medium.

As another aspect of embodiments of the present invention, a method of manufacturing the toner mentioned above is provided which includes manufacturing a base toner particle containing the polyester resin and the styrene resin, wherein the proportion of the styrene resin in the manufacturing the base toner particle is from 5 to 10 parts by mass to the entire amount of 100 parts by mass of the base toner particle.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an example of the image forming apparatus of the present invention;

FIG. 2 is a schematic diagram illustrating another example of the image forming apparatus of the present invention;

FIG. 3 is a schematic diagram illustrating yet another example of the image forming apparatus of the present invention;

FIG. 4 is a schematic diagram illustrating an image forming unit of the image forming apparatus of the present invention; and

FIG. 5 is a diagram illustrating a schematic configuration of the process cartridge according to an embodiment of the present invention.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a toner is provided which has excellent low temperature fixability and reduces filming in a severe condition such as high temperature and humidity.

A pulverized toner has been proposed in Japanese Unexamined Patent Application Pulverization No. 2005-62599 in an attempt to facilitate pulverization during production and excel in fixing stability. The toner is produced by pulverizing and classifying a composition that includes a styrene-based resin. In this composition, a styrene-based resin with a weight average molecular weight (Mw) exceeding 3,000 is added to a mixture of a binder resin and a colorant. Additionally, another pulverized toner has been proposed in Japanese Unexamined Patent Application Pulverization No. 2021-144186 in an attempt to balance between both low temperature fixability and high temperature storage stability. This pulverized toner specifies the maximum peak ratio between polyester resin and styrene resin by Fourier Transform Infrared Spectroscopy (FT-IR).

Typical toners, including the toners described in Japanese Unexamined Patent Application Pulverization No. 2005-62599 and Japanese Unexamined Patent Application Pulverization No. 2021-144186 mentioned above raises a concern about image defects caused by filming, which occurs when low-heat-resistant wax or polyester resin exposed on the toner surface adheres to the photoconductor. This issue is particularly pronounced in high-temperature and high-humidity environments and can cause similar image defects even when the printing area is small.

In contrast to the related art described above, the toner of the present invention solves the aforementioned issues by containing polyester resin and styrene resin, along with a peak ratio (R1/W1) between 1.00 and 2.00, where R1 represents the maximum peak height in a range of 710 cm⁻¹ to 690 cm⁻¹ of a Fourier Transform Infrared Spectroscopy (FT-IR) spectrum of the toner measured by the Attenuated Total Reflection (ATR) method and W1 represents the maximum peak height in a range of 789 cm⁻¹ to 852 cm⁻¹ of the FT-IR spectrum of the toner measured by ATR method. Additionally, it also has a peak ratio (R2/W2) of between 0.80 and 1.20, where R2 represents the maximum peak height in a range of 710 cm⁻¹ to 690 cm⁻¹ of an FT-IR spectrum of the toner measured by KBr tablet method (hereinafter referred to as KBr method) and W2 represents the maximum peak height in a range of 789 cm⁻¹ to 852 cm⁻¹ of the FT-IR spectrum of the toner measured by KBr method. More specifically, the specified peak ratios enable the toner of the present invention to exhibit excellent low temperature fixability and can reduce filming even in high-temperature and high-humidity environments.

The present disclosure is described in detail below.

### Toner

The toner of the present invention contains a polyester resin and a styrene resin, along with other optional components such as a colorant and an external additive.

The toner of the present invention has a peak ratio (R1/W1) of between 1.00 and 2.00, where R1 represents the maximum peak height in a range of 710 cm⁻¹ to 690 cm⁻¹ of a Fourier Transform Infrared Spectroscopy (FT-IR) spectrum of the toner measured by Attenuated Total Reflection (ATR) method and W1 represents the maximum peak height in a range of 789 cm⁻¹ to 852 cm⁻¹ of the FT-IR spectrum of the toner measured by ATR method. Additionally, it also has a peak ratio (R2/W2) of between 0.80 and 1.20, where R2 represents the maximum peak height in a range of 710 cm⁻¹ to 690 cm⁻¹ of an FT-IR spectrum of the toner measured by KBr tablet method (hereinafter referred to as KBr method) and W2 represents the maximum peak height toner in a range of 789 cm⁻¹ to 852 cm⁻¹ of the FT-IR spectrum of the measured by KBr method. In the present specification, the maximum peak height in a range of 789 cm⁻¹ to 852 cm⁻¹ in the FT-IR spectrum of the toner measured by ATR method is also simply referred to as W1, and the maximum peak height in a range of 710 cm⁻¹ to 690 cm⁻¹ in the FT-IR spectrum of the toner measured by ATR method is also simply referred to as R1. Additionally, the maximum peak height in a range of 789 cm⁻¹ to 852 cm⁻¹ in the FT-IR spectrum of the toner measured by KBr method is also simply referred to as W2, and the maximum peak height in a range of 710 cm⁻¹ to 690 cm⁻¹ in the FT-IR spectrum of the toner measured by KBr method is also simply referred to as R2.

Furthermore, in a specific FT-IR spectrum where multiple peaks are present, the highest peak among them is considered the maximum peak height.

In the present specification, FT-IR refers to a Fourier Transform Infrared Spectrometer.

In the present specification, ATR method refers to the Attenuated Total Reflection method.

In the present specification, KBr tablet method refers to the transmission method using potassium bromide (KBr) tablets.

The spectrum in the FT-IR spectrum in a range of 789 cm⁻¹ to 852 cm⁻¹ is derived from the polyester resin. The spectrum in the FT-IR spectrum in a range of 710 cm⁻¹ to 690 cm⁻¹ is derived from the styrene resin.

The ATR method enables the qualitative and quantitative analysis of substances present on the toner's surface. Additionally, the KBr method allows for the qualitative and quantitative analysis of the entire toner.

Specifically, a peak ratio [R1/W1] of 1.00 to 2.00 and a peak ratio [R2/W2] of 0.80 to 1.20 indicate that the styrene resin is unevenly distributed on the toner surface. Such toners exhibit excellent low-temperature fixability and high temperature storage stability because the styrene resin, which is exposed on the outermost surface of the toner, excels in high temperature storage stability and grindability, while the toner encapsulates materials with low heat resistance, such as wax.

The peak ratio (R1/W1) is between 1.00 and 2.00, preferably between 1.20 and 1.50.

When the peak ratio (R1/W1) is 1.00 or more, a sufficient amount of styrene resin is present on the toner surface, which reduces filming of the polyester resin onto the photoconductor under high temperature and high humidity conditions, thereby preventing the occurrence of abnormal images such as black streaks.

When the peak ratio (R1/W1) is 2.00 or less, the amount of styrene resin present on the toner surface is appropriate, which makes the toner less prone to melting and reduces the occurrence of issues such as poor fixing.

The peak ratio (R2/W2) is between 0.80 and 1.20, preferably between 0.90 and 1.10.

In the case of printing images with a low image area ratio, a peak ratio (R2/W2) of 0.80 or higher reduces the occurrence of filming on the photoconductor caused by an increase in the amount of the toner's polyester resin, which excels in low temperature fixability, leading to the melting of the toner by frictional heat.

When the peak ratio (R2/W2) is 1.20 or less, the toner has appropriate thermal properties, which helps to reduce the occurrence of issues such as poor fixing.

There are no particular restrictions on the control method of setting the peak ratio (R1/W1) between 1.00 and 2.00 and the peak ratio (R2/W2) between 0.80 and 1.20. One way of controlling these ratios includes appropriately adjusting the amount of styrene resin, which is easy to pulverize during the toner production process.

The amount of styrene resin added can be appropriately adjusted according to the materials of the toner. As will be described in detail later, the amount of styrene resin added during the base toner particle production process is preferably between 5 parts by mass and 10 parts by mass, assuming the total amount of the toner base particles is 100 parts by mass.

In the present invention, there are no particular restrictions on the method of measuring the FT-IR spectrum, and it can be appropriately selected according to the purpose. One such measuring device is the Thermo Nicolet NEXUS 470 (available from Thermo SCIENTIFIC). The following is a description about one of the measuring methods.

### An Example of Method of Measuring FT-IR Spectrum

Measuring Device: Thermo Nicolet NEXUS 470 (available from Thermo SCIENTIFIC)
Resolution: 4 cm⁻¹
Number of Sample Accumulations: 16 Scans
Number of Background Accumulations: 16 Scans
Wavenumber Range Saved: 4,000 to 400 cm⁻¹

From the FT-IR spectrum obtained under the above measurement conditions, baseline correction is performed in a range of 900 cm⁻¹ to 750 cm⁻¹ to determine the maximum peak value of the polyester. Similarly, baseline correction is performed in a range of 800 cm⁻¹ to 600 cm⁻¹ to determine the maximum peak value of the styrene resin.

### Polyester Resin

There are no particular restrictions on the polyester resin, and it can be appropriately selected according to the purpose. Using a mixture of crystalline polyester resin and amorphous polyester resin is preferable to further improve thermal properties.

### Crystalline Polyester Resin

The crystalline polyester resin, also referred to as crystalline polyester resin C, has a high crystallinity, so that it has a heat-melt property demonstrating a sharp change in viscosity around the fixing starting temperature. When such a resin with these characteristics is used in combination with an amorphous polyester resin, the high temperature storage stability becomes excellent up to just before the melting start temperature due to its crystallinity. At the melting start temperature, there is a sharp decrease in viscosity (sharp melt) due to the melting of the crystalline polyester resin. Consequently, this change causes mixing of the crystalline polyester resin with the amorphous polyester resin, leading to production of toner with excellent high temperature storage stability and low-temperature fixing properties.

Additionally, the release width (the difference between the lower fixing limit temperature and the temperature at which high-temperature offset occurs) also becomes excellent.

The crystalline polyester resin can be prepared by a polyol with a polycarboxylic acid including a polycarboxylic anhydride and polycarboxylic acid ester or their derivatives.

In the present invention, the crystalline polyester resin refers to a substance obtained by using a polyol and a polycarboxylic acid including a polycarboxylic anhydride and polycarboxylic acid ester or their derivatives as described above. The crystalline polyester resin excludes modified polyester resin obtained by the prepolymer which is described later and resin obtained by cross-linking and/or elongating the prepolymer.

### Polyhydric Alcohol

The polyhydric alcohol is not particularly limited and can be suitably selected to suit to a particular application. Examples include, but are not limited to, diol and tri- or higher alcohols.

One example of diol is saturated aliphatic diol. Examples of the saturated aliphatic diol include, but are not limited to, linear saturated aliphatic diols and branched saturated aliphatic diols. Of these, linear saturated aliphatic diols are preferred to prevent the lowering of the melting point due to a decrease in the crystallinity. From the viewpoint of availability, linear saturated aliphatic diols with 2 to 12 carbon atoms are more preferred.

Specific examples of the saturated aliphatic diol include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosandecanediol. Of these, ethylene glycol, 1,4-butanediol, 1,6-hexanediol, 1,8-octanediol, 1,10-decanediol, and 1,12-dodecanediol are preferable to enhance crystallinity of the crystalline polyester resin and achieve excellent sharp melting thereof. These can be used alone or in combination.

Specific examples of the tri- or higher alcohol include, but are not limited to, glycerin, trimethylol ethane, trimethylol propane, and pentaerythritol. These diols can be used alone or in combination.

### Polycarboxylic Acid

The polycarboxylic acid mentioned above is not particularly limited and can be suitably selected to suit to a particular application. Examples include, but are not limited to, dicarboxylic acid and tri- or higher carboxylic acid. These dicarboxylic acids can be used alone or in combination.

Specific examples of dicarboxylic acids include, but are not limited to, saturated aliphatic dicarboxylic acid such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid and aromatic dicarboxylic acids of diprotic acids including phthalic acid, isophthalic acid, terephthalic acid, naphthalene-2,6-dicarboxylic acid, malonic acid, and mesaconic acid. They also include anhydrides or lower alkylesters (1 to 3 carbon atoms) thereof.

Specific examples of the tri- or higher carboxylic acids include, but are not limited to, 1,2,4-benzene tricarboxylic acid, 1,2,5-benzene tricarboxylic acid, and 1,2,4-naphtalene tricarboxylic acid. They also include anhydrides or lower alkylesters (1 to 3 carbon atoms) thereof.

In addition to the saturated aliphatic dicarboxylic acid and the aromatic dicarboxylic acid, a dicarboxylic acid having a sulfonic acid group and a dicarboxylic acid having a double bond can be used as the polycarboxylic acid.

The crystalline polyester resin is preferably formed of a linear saturated aliphatic dicarboxylic acid with 4 to 12 carbon atoms and a linear saturated aliphatic diol with 2 to 12 carbon atoms. In other words, the crystalline polyester resin preferably contains structural units derived from a saturated aliphatic dicarboxylic acid with 4 to 12 carbon atoms and structural units derived from a saturated aliphatic diol with 2 to 12 carbon atoms. This crystalline polyester resin thus demonstrates high crystallinity and excellent sharp melting, thereby achieving excellent low temperature fixability, which is preferable.

The melting point of the crystalline polyester resin is not particularly limited and can be suitably selected to suit to a particular application. It is preferably from 60 to 80 degrees Celsius.

A melting point of the crystalline polyester resin of 60 or higher degrees Celsius is preferable because it can prevent a decrease in the high temperature storage stability of the toner due to the crystalline polyester resin melting at low temperatures.

A melting point of the crystalline polyester resin of 80 or lower degrees Celsius is preferable because it can prevent a decrease in the low-temperature fixability of the toner due to insufficient melting of the crystalline polyester resin during the fixing process.

The molecular weight of the crystalline polyester resin is not particularly limited and can be suitably selected to suit to a particular application. It is to be noted that while lower molecular weight components with a sharp distribution exhibits excellent low temperature fixability, an excess of these components may compromise high temperature storage stability. Therefore, the soluble fraction of the crystalline polyester resin in ortho-dichlorobenzene, as measured by gel permeation chromatography (GPC), is preferably within a range of weight-average molecular weight Mw of 3,000 to 30,000, number-average molecular weight Mn of 1,000 to 10,000, and Mw/Mn ratio of 1.0 to 10.

Furthermore, it is more preferable that the soluble fraction of the crystalline polyester resin in ortho-dichlorobenzene, as measured by gel permeation chromatography (GPC), has a weight average molecular weight Mw of 5,000 to 15,000, a number average molecular weight Mn of 2,000 to 10,000, and an Mw/Mn ratio of 1.0 to 5.0.

The number average molecular weight Mn and the weight average molecular weight Mw can be measured with gel permeation chromatography (GPC), for example, under the following conditions:

### Measuring Conditions

An example of device: HLC-8120, available from TOSOH CORPORATION
An example of column: TSK GEL GMH6, available from TOSOH CORPORATION, two columns
Measuring temperature: 40 degrees Celsius
Sample solution: 0.25 percent by mass tetrahydrofuran solution (non-dissolved portion filtered with glass filter)
Amount of solution infused: 100 μL
Detector: Refractive index detector
Reference materials: Standard polystyrene (TSK standard polystyrene) with 12 materials (molecular weights: 500, 1,050, 2,800, 5,970, 9,100, 18,100, 37,900, 96,400, 190,000, 355,000, 1,090,000, and 2,890,000) (available from TOSOH CORPORATION)

The acid value of the crystalline polyester resin is not particularly limited and can be suitably selected to suit to a particular application; it is, however, preferably 5 or more mgKOH/g, and more preferably 10 or more mgKOH/g to achieve target low temperature fixing properties in terms of affinity between the recording medium (typically paper) described later and the resin. Conversely, to enhance the hot offset resistance, the acid value is preferably 45 or lower mgKOH/g.

The hydroxyl value of the crystalline polyester resin is not particularly limited and can be suitably selected to suit to a particular application; it is, however, preferably 0 to 50 mgKOH/g and more preferably 5 to 50 mgKOH/g to achieve target low temperature fixing properties and good chargeability.

The molecular structure of the crystalline polyester resin can be analyzed in solution or solid state using NMR, along with other methods such as X-ray diffraction, GC/MS, LC/MS, and infrared (IR) absorption. A simple method of detecting a crystalline polyester resin involves identifying substances that exhibit absorption based on the 8CH (out-of-plane vending vibration) of olefins at 965 cm−1±10 cm⁻¹ or 990 cm−1±10 cm⁻¹ in the infrared absorption spectrum as crystalline polyester resin.

The proportion of the crystalline polyester resin is not particularly limited and can be suitably selected to suit to a particular application. The number of parts of the crystalline polyester resin is preferably from 3 to 20 parts by mass and more preferably from 5 to 15 parts by mass to 100 parts of the toner mentioned above.

If the content of the crystalline polyester resin is at least 3 parts by mass per 100 parts by mass of the toner, the crystalline polyester resin can achieve sharp melting, leading to good low-temperature fixability, which is preferable.

If the content of the crystalline polyester resin is not more than 20 parts by mass per 100 parts by mass of the toner, high temperature storage stability is improved, resulting in high-quality images, which is preferable.

### Amorphous Polyester Resin

The amorphous polyester resin mentioned above is not particularly limited and crystalline polyester resin. For example, amorphous polyester resin A, with a glass transition temperature (Tg) of −40 to 20 degrees Celsius, and non-crystalline polyester resin B, with a glass transition temperature (Tg) of 40 to 80 degrees Celsius, can be listed.

### Amorphous Polyester Resin A

The amorphous polyester resin A is not particularly limited as long as its glass transition temperature (Tg) is −40 to 20 degrees Celsius, and can be suitably selected to suit to a particular application.

It is preferable for the amorphous polyester resin A to be obtained by the reaction between a non-linear reactive precursor and a curing agent.

Additionally, it is preferable for the amorphous polyester resin A to have at least one of urethane bonds and urea bonds, as it exhibits better adhesion to recording media such as paper. The urethane bonds or urea bonds in the amorphous polyester resin A show behavior similar to pseudo-crosslinking, enhancing the rubber-like properties of the amorphous polyester resin A and improving the high temperature storage stability and resistance to high-temperature offset of the toner.

### Non-Linear Reactive Precursor

The non-linear precursor may be any polyester resin (referred to as a prepolymer hereafter) having reactive groups capable of reacting with a curing agent, without particular limitations, and can be appropriately selected according to the purpose. Non-linear refers to a branched structure resulting from the presence of at least one tri- or higher alcohol or tri- or higher carboxylic acid.

In the case that the reactive precursor in the aforementioned amorphous polyester resin A is non-linear, it has a branched structure in the molecular skeleton, resulting in a three-dimensional network of molecular chains. This structure imparts rubber-like properties, allowing itself to deform at low temperatures without flowing. Therefore, it becomes possible to maintain the heat resistance storage stability and resistance to high-temperature offset of the toner.

One of a reactive group-within the prepolymer-capable of reacting with the curing agent is one that can react with an active hydrogen group. Specific examples of the group reactive with an active hydrogen group include, but are not limited to, an isocyanate group, an epoxy group, a carboxylic acid, and an acid chloride group. Of these, an isocyanate group is preferable to introduce a urethane or urea bond into an amorphous polyester resin.

As the prepolymer, a polyester resin containing an isocyanate group is preferable.

The polyester resin containing an isocyanate group is not particularly limited and can be suitably selected to suit to a particular application. One example is a reaction product of a polyisocyanate and a polyester resin with an active hydrogen group. One way of obtaining a polyester resin with an active hydrogen group involves polycondensing a diol with a dicarboxylic acid or a tri- or higher alcohol with a tri- or higher carboxylic acid. Polycondensation of a tri- or higher alcohol and a tri- or higher carboxylic acid results in a branch-structured polyester resin with an isocyanate group.

The diols are not particularly limited and can be suitably selected to suit to a particular application.

Specific examples include, but are not limited to, aliphatic diols such as ethylene glycol, 1,2-propylene glycol, 1,3-propylene glycol, 1,4-butanediol, 1,5-pentanediol, 1,6-hexanediol, 1.8-octanediol, 1,10-decanediol, and 1,12-dodecanediol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide. Of these, aliphatic diols with 4 to 12 carbon atoms are preferable.

These diols can be used alone or in combination.

The dicarboxylic acid is not particularly limited and can be suitably selected to suit to a particular application. It includes an aliphatic dicarboxylic acid and an aromatic dicarboxylic acid, for example. These anhydrides, lower (1 to 3 carbon atoms) alkylester compounds, or halogenated compounds can be used.

The aliphatic dicarboxylic acids are not particularly limited and can be suitably selected to suit to a particular application.

Specific examples include, but are not limited to, succinic acid, adipic acid, sebacic acid, dodecanedioic acid, maleic acid, and fumaric acid.

The aromatic dicarboxylic acids are not specifically restricted and can be chosen as needed for the purpose. It is preferably aromatic dicarboxylic acids with 8 to 20 carbon atoms. For aromatic dicarboxylic acids with 8 to 20 carbon atoms, there are no specific restrictions, and they can be chosen as needed for the purpose. Examples include, but are not limited to, phthalic acid, isophthalic acid, terephthalic acid, and naphthalenedicarboxylic acid.

Of these, aliphatic dicarboxylic acids with 4 to 12 carbon atoms are preferable.

These dicarboxylic acids can be used alone or in combination.

The tri- or higher alcohol is not particularly limited and can be suitably selected to suit to a particular application. It includes a tri- or higher aliphatic alcohol, a tri- or higher polyphenol, and an adduct of polyphenol with alkylene oxide.

Specific examples of tri- or higher aliphatic alcohol include, but are not limited to, glycerin, trimethylol ethane, trimethylol propane, pentaerythritol, and sorbitol.

Specific examples of ti- or higher polyphenol include, but are not limited to, trisphenol PA, phenol novolac, and cresol novolac.

Specific examples of the adduct of polyphenols with tri- or higher alkylene oxide include, but are not limited to, an adduct of tri- or higher polyphenol with alkylene oxide such as ethylene oxide, propylene oxide, and butylene oxide.

It is preferable for the amorphous polyester resin A to include an aliphatic alcohol with a valence of three or more as a constituent component.

Inclusion of an aliphatic alcohol with a valence of three or more as a constituent component in the amorphous polyester resin A leads to a branched structure in the molecular skeleton, resulting in a three-dimensional network structure of molecular chains. This structure possesses rubber-like properties that allow itself to deform at low temperatures without flowing. Therefore, it becomes possible to maintain the high temperature storage stability and resistance to high-temperature offset of the toner.

The amorphous polyester resin A can also use trivalent or higher carboxylic acids or epoxies as cross-linking components. However, in the case of carboxylic acids, which are often aromatic compounds, the high density of ester bonds in the cross-linked sections may prevent the toner from achieving sufficient gloss in the fixed images formed by heat fixing. Cross-linking agents such as epoxies are used to conduct the cross-linking reaction after the polymerization of the polyester, which makes it difficult to control the distance between cross-linking points and potentially fails to achieve the desired viscoelasticity.

Furthermore, cross-linking agents may react with oligomers produced during polyesterization, thereby forming high-density cross-linked regions, which can lead to unevenness in the fixed images, resulting in poorer gloss and image density.

The trivalent or higher-valent carboxylic acid is not particularly limited and can be suitably selected to suit to a particular application. It includes a trivalent or higher-valent aromatic carboxylic acid. Their anhydrides, lower (1 to 3 carbon atoms) alkylester compounds, or halogenated compounds can be also used.

Tri-or higher aromatic carboxylic acid preferably has 9 to 20 carbon atoms.

Specific examples of tri- or higher aromatic carboxylic acid having 9 to 20 carbon atoms include, but are not limited to, trimellitic acid and pyromellitic acid.

The polyisocyanate mentioned above is not particularly limited and can be suitably selected to suit to a particular application. Examples include, but are not limited to, diisocyanate and tri- or higher isocyanate.

Examples of the diisocyanates include, but are not limited to, aliphatic diisocyanates, alicyclic diisocyanates, aromatic diisocyanates, arylaliphatic diisocyanates, isocyanurates, and their blocked forms using a substance such as phenol derivatives, oximes, and caprolactam.

The aliphatic diisocyanate is not particularly limited and can be suitably selected to suit to a particular application.

Specific examples of the aliphatic di-isocyanates include, but are not limited to, tetramethylene diisocyanate, hexamethylene diisocyanate and 2,6-diisocyanate methylcaproate, octamethylene diisocyanate, decamethylene diisocyanate, dodecamethylene diisocyanate, tetradecamethylene diisocyanate, trimethyl hexane diisocyanate, and tetramethyl hexane diisocyanate.

The alicyclic diisocyanate is not particularly limited and can be suitably selected to suit to a particular application.

Specific examples include, but are not limited to, isophorone diisocyanate and dicyclohexylmethane diisocyanate.

The aromatic diisocyanate is not particularly limited and can be suitably selected to suit to a particular application.

Specific examples include, but are not limited to, tolylene diisocyanate, diphenylmethane diisocyanate, 1,5-naphthylene diisocyanate, 4,4-diisocyanate-3,3′-dimethyldiphenyl, 4,4′-diisocyanate-3-methyl diphenylmethane, and 4,4′-diisocyanate-diphenyl ether.

There is no specific limitation to the aromatic-aliphatic diisocyanates, and they can be chosen as needed for the purpose. One example is α,α,α′,α′-tetramethylxylylene diisocyanate.

Similarly, for isocyanurate compounds, there are no specific restrictions, and they can be chosen as needed for the purpose. Some examples include, but are not limited to, tris (isocyanatoalkyl) isocyanurates and tris (isocyanatocycloalkyl) isocyanurates.

These polyisocyanate can be used alone or in combination.

### Curing Agent

The curing agent is not particularly limited as long as it can react with the non-linear reactive precursor to produce the amorphous polyester resin A, and it can be appropriately selected according to the purpose. Examples include compounds containing active hydrogen groups.

The active hydrogen group of the compound containing an active hydrogen group has no particular limit and can be suitably selected to suit to a particular application. For example, hydroxyl group (alcoholic hydroxyl group or phenolic hydroxyl group), amino group, carboxyl group, and mercapto group can be listed. These can be used alone or in combination.

The compound containing an active hydrogen group is not particularly limited and can be suitably selected to suit to a particular application. Amines are preferable to form urea bonds.

The amine mentioned above is not particularly limited and can be suitably selected to suit to a particular application. Specific examples include, but are not limited to, diamines, amines with three or more valences, amino alcohols, amino mercaptans, amino acids, and their blocked derivatives. Of these, dimine and a mixture of dimaine with a minute amount of polyamines having three or more amino groups are preferable.

These can be used alone or in combination.

The diamines are not particularly limited and can be chosen as appropriate for the purpose, such as aromatic diamines, cycloaliphatic diamines, aliphatic diamines, and more.

There are no specific limitations on aromatic diamines, and they can be selected as appropriate for the purpose. Examples include, but are not limited to, phenylenediamines, diethyltoluenediamines, and 4,4′-diaminodiphenylmethane.

Similarly, there are no particular restrictions on cycloaliphatic diamines, and they can be selected based on the intended purpose. Some examples include, but are not limited to, 4,4′-diamino-3,3′-dimethyl-dicyclohexylmethane, diaminocyclohexane, and isophoronediamine.

For aliphatic diamines, there are no specific limitations, and they can be chosen according to the intended purpose. Some examples include, but are not limited to, ethylenediamine, tetramethylenediamine, and hexamethylenediamine.

As for the trivalent or higher amines, there are no specific restrictions, and they can be selected as needed for the purpose. Some examples include, but are not limited to, diethylenetriamine, triethylenetetramine,

The amino alcohols are not specifically restricted and can be chosen as needed for the purpose. Some examples include, but are not limited to, ethanolamine and hydroxyethyl aniline.

Similarly, the amino mercaptans are not specifically restricted and can be chosen to suit to a particular application. Some examples include, but are not limited to, aminoethyl mercaptan, and aminopropyl mercaptan.

The amino acids have no particular limit and can be suitably selected to suit to a particular application. For example, amino propoionic acid and amino caproic acid are usable.

Similarly, for the blocked amino group, there are no specific restrictions, and they can be chosen as needed for the purpose.

Specific examples include, but are not limited to, ketimine compounds and oxazoline compounds prepared by blocking an amino group with a ketone such as acetone, methyl ethyl ketone, and methyl isobutyl ketone,

The amorphous polyester resin A preferably includes a diol component as a constituent, with the diol component containing at least 50 percent by mass of an aliphatic diol having 4 to 12 carbon atoms. Such amorphous polyester resin A is preferred because it can lower the glass transition temperature (Tg), thereby facilitating the toner to be deformable at low temperatures.

The amorphous polyester resin A preferably contains at least 50 percent by mass of an aliphatic diol having 4 to 12 carbon atoms among the total alcohol components. Such amorphous polyester resin A is preferred because it can lower the glass transition temperature (Tg), thereby facilitating the toner to be deformable at low temperatures.

The amorphous polyester resin A preferably includes a dicarboxylic acid component as a constituent, with the dicarboxylic acid component containing at least 50 percent by mass of an aliphatic dicarboxylic acid having 4 to 12 carbon atoms. Such amorphous polyester resin A is preferred because it can lower the glass transition temperature (Tg), thereby facilitating the toner to be deformable at low temperatures.

The weight average molecular weight of the amorphous polyester resin A is not particularly limited and can be suitably selected to suit to a particular application. It is preferably from 20,000 to 1,000,000, more preferably from 50,000 to 300,000, and furthermore preferably from 100,000 to 200,000 as measured by gel permeation chromatography (GPC).

The amorphous polyester resin A with a weight average molecular weight of at least 20,000 helps to solve problems such as the toner becoming too fluid at low temperatures, leading to poor high temperature storage stability, and decreased viscosity during melting, which in turn lowers the high-temperature offset resistance.

The molecular structure of the amorphous polyester resin A can be analyzed in solution or solid state using nuclear magnetic resonance (NMR), along with other methods such as X-ray diffraction, Gas Chromatography-Mass spectrometry (GC/MS), Liquid Chromatograph-Mass Spectrometry (LC/MS), and infrared (IR) absorption. A simple method of detecting an amorphous polyester resin involves identifying substances that exhibit absorption based on the δCH (out-of-plane vending vibration) of olefins at 965 cm−1±10 cm⁻¹ or 990 cm−1±10 cm⁻¹ in the infrared absorption spectrum as amorphous polyester resin A.

The proportion of the amorphous polyester resin A is not particularly limited and can be suitably selected to suit to a particular application. The number of parts of the amorphous polyester resin A is preferably from 5 to 25 parts by mass and more preferably from 10 to 20 parts by mass to 100 parts by mass of the toner mentioned above.

A content of at least 5 parts by mass of amorphous polyester resin A per 100 parts by mass of the toner is preferable, as it facilitates fixing at low temperatures and prevents offsetting at high temperatures.

A content of not more than 25 parts by mass of amorphous polyester resin A per 100 parts by mass of the toner is preferable for stable storage in a high-temperature environment and for obtaining images with better gloss after fixing.

Thus, having the content of the amorphous polyester resin A within the preferred range is advantageous, as it excels in the low-temperature fixability, high-temperature offset resistance, and high temperature storage stability.

### Amorphous Polyester Resin B

The amorphous polyester resin B is not particularly limited as long as its glass transition temperature (Tg) is 40 to 80 degrees Celsius, and can be suitably selected to suit to a particular application.

The amorphous polyester resin B is preferably a linear polyester resin.

Preferably, the amorphous polyester resin B is free of a urethane or urea bonding.

The amorphous polyester resin B is preferably an unmodified polyester resin.

The unmodified polyester resin is obtained using a polyol with a polycarboxylic acid including polycarboxylic anhydride, polycarboxylic acid ester, and their derivatives. It is not modified with a substance such as an isocyanate compound.

One such polyol is a diol.

Specific examples of the diol includes, but are not limited to, an adduct of bisphenol A with alkylene (having two or three carbon atoms) oxide (average adduction mol number of from 1 to 10) such as polyoxypropylene (2)-2,2-bis(4-hydroxyphenyl)propane, polyoxyethylene(2)-2,2-bis(4-hydroxyphenyl)propane, ethylene glycol, propylene glycol, hydrogenated bisphenol A, and an adduct of hydrogenated bisphenol A with an alkylene (having two or three carbon atoms) oxide (average adduction mol number of from 1 to 10).

These can be used alone or in combination.

A specific example of the polycarboxylic acid is dicarboxylic acid.

Specific examples of the dicarboxylic acids include, but are not limited to, adipic acid, phthalic acid, isophthalic acid, terephthalic acid, fumaric acid, maleic acid, and succinic acid substituted with an alkyl group having 1 to 20 carbon atoms or alkenyl group having 2 to 20 carbon atoms such as dodecenyl succinic acid and octyl succinic acid.

These can be used alone or in combination.

The amorphous polyester resin B contains a dicarboxylic acid component, preferably containing terephthalic acid in an amount of at least 50 mol percent. Such amorphous polyester resins are advantageous for stable storage in a high temperature environment.

The amorphous polyester resin B mentioned above may optionally contain at least one of a tri- or higher carboxylic acid and a tri- or higher alcohol at the terminal of its resin chain to adjust the acid value and hydroxyl values.

Specific examples of tri- or higher carboxylic acid include, but are not limited to, trimellitic acid, pyromellitic acid, and their anhydrides.

Specific examples of tri- or higher alcohol include, but are not limited to, glycerin, pentaerythritol, and trimethylol propane.

The molecular weight of the amorphous polyester resin B is not particularly limited and can be appropriately selected according to the purpose. In gel permeation chromatography (GPC) measurements, the weight average molecular weight (Mw) is preferably 3,000 to 10,000 and more preferably 4,000 to 7,000, the number average molecular weight Mn is preferably 1,000 to 4,000 and more preferably 1,500 to 3,000, and the Mw/Mn ratio is preferably 1.0 to 4.0 and more preferably 1.0 to 3.5.

If the molecular weight of the amorphous polyester resin B is too low, the toner may have poor high temperature storage stability and durability against stresses such as agitation in the developing machine. Conversely, if the molecular weight is too high, the toner may have high viscoelasticity during melting, leading to poor low-temperature fixability. Within the above preferable ranges, these issues can be resolved, qhich is suitable.

The acid value of the amorphous polyester resin B has no particular limit and can be suitably selected to suit to a particular application. A range of 1 to 50 mg KOH/g is preferable, with 5 to 30 mg KOH/g being even more favorable.

An acid value of at least 1 mgKOH/g tends to negatively charge a toner and enhances the affinity between a recording medium such as paper and the toner during fixing on the recording medium, enhancing the low temperature fixability.

An acid value of the amorphous polyester resin B of not greater than 50 mg KOH/g enhances the charge stability, particularly the charge stability against environmental changes.

The hydroxyl value of the amorphous polyester resin B is not particularly limited and can be suitably selected to suit to a particular application. The value is preferably at least 5 mgKOH/g.

The glass transition temperature Tg of the amorphous polyester resin B is preferably from 40 to 80 degrees Celsius and more preferably from 50 to 70 degrees Celsius.

A glass transition temperature of the amorphous polyester resin B of at least 40 degrees Celsius enhances the toner's high temperature storage stability and its durability to stress such as stirring in a developing device while enhancing the resistance to filming.

A glass transition temperature of the amorphous polyester resin B of at least 80 degrees Celsius suitably transforms the shape of toner with heat and pressure in fixing, thereby enhancing the low temperature fixability.

The method of measuring the glass transition temperature of the amorphous polyester resin A and the amorphous polyester resin B is not particularly limited and can be suitably selected to suit to a particular application. For example, it can be measured with a differential scanning calorimeter (Q-200, available from TA Instruments). A specific measuring method is as follows.

### Example of Method of Measuring Glass Transition Temperature (Tg)

About 5.0 mg of a target sample is put in an aluminum sample container, which is placed on a holder unit. The unit and the container are then disposed in an electric furnace. Next, under a nitrogen atmosphere, the temperature is raised from −80 to 150 degrees Celsius at a temperature rising rate of 10 degrees Celsius per minute. The glass transition temperature (Tg) of the sample is then determined using the analysis program installed in the differential scanning calorimeter (DSC) from the obtained DSC curve.

The molecular structure of the amorphous polyester resin B can be analyzed in solution or solid state using nuclear magnetic resonance (NMR), along with other methods such as X-ray diffraction, Gas Chromatography-Mass spectrometry (GC/MS), Liquid Chromatograph-Mass Spectrometry (LC/MS), and infrared (IR) absorption. A simple method of detecting an amorphous polyester resin involves identifying substances that exhibit absorption based on the δCH (out-of-plane vending vibration) of olefins at 965 cm−1±10 cm⁻¹ or 990 cm−1±10 cm⁻¹ in the infrared absorption spectrum as amorphous polyester resin B.

The proportion of the amorphous polyester resin B is not particularly limited and can be suitably selected to suit to a particular application. The number of parts of the amorphous polyester resin A is preferably from 50 to 90 parts by mass and more preferably from 60 to 80 parts by mass to 100 parts by mass of the toner mentioned above.

A content of the amorphous polyester resin B of at least 50 parts by mass per 100 parts by mass of the toner enhances the dispersibility of the pigment and the release agent in the toner, making it possible to reduce the occurrence of image fogging and disturbances, which is preferable.

When the content of the amorphous polyester resin B is 90 parts by mass or more per 100 parts by mass of the toner, the content of the crystalline polyester resin C and the amorphous polyester resin A becomes appropriate, resulting in good low-temperature fixability, which is preferable.

When the content of the amorphous polyester resin B is between 60 parts by mass and 80 parts by mass per 100 parts by mass of the toner, it is advantageous as it excels in both high image quality and low-temperature fixability.

It is preferable to use the amorphous polyester resin A in combination with the crystalline polyester resin for fixing at low temperatures.

To strike a balance between the low temperature fixability and high-temperature high-humidity storage stability, it is preferable that the amorphous polyester resin A have a low glass transition temperature. The amorphous polyester resin A with a low glass transition temperature deforms under heat and pressure during fixing, making it casier to adhere to recording media such as paper at lower temperatures, which is preferable.

### Styrene Resin

There are no particular restrictions on the styrene resin used in the present invention, and it can be appropriately selected according to the purpose.

Examples include, but are not limited to, polymers of styrene and its derivatives, such as polystyrene, poly-p-styrene, polyvinyltoluene, styrene-a-methylstyrene copolymer, styrene-p-chlorostyrene copolymer, styrene-propylene copolymer, styrene-vinyltoluene copolymer, styrene-methyl acrylate copolymer, styrene-ethyl acrylate copolymer, styrene-butyl acrylate copolymer, styrene-methyl methacrylate copolymer, styrene-ethyl methacrylate copolymer, styrene-butyl methacrylate copolymer, styrene-a-chloro methyl methacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleic acid copolymer, and styrene-maleic acid ester copolymer.

The glass transition temperature Tg of the styrene resin is preferably at least 60 degrees Celsius, more preferably from 80 to 90 degrees Celsius, and even more preferably 83 to 87 degrees Celsius to improve the high temperature storage stability.

A glass transition temperature Tg of the styrene resin of at least 83 degrees Celsius is preferable to prevent filming.

A styrene resin with a glass transition temperature Tg of at least 87 degrees Celsius is preferable for low temperature fixing.

The method of measuring the glass transition temperature Tg is not particularly limited and can be suitably selected to suit to a particular application. For example, it can be measured with a differential scanning calorimeter (Q-200, available from TA Instruments). A specific measuring method is as follows.

### Example of Method of Measuring Glass Transition Temperature (Tg)

About 5.0 mg of a target sample is put in an aluminum sample container, which is then placed on a holder unit. The unit and the container are sequentially disposed in an electric furnace. Next, under a nitrogen atmosphere, the temperature is raised from −80 to 150 degrees Celsius at a temperature rising rate of 10 degrees Celsius per minute. The glass transition temperature (Tg) of the sample is then determined using the analysis program installed in the differential scanning calorimeter (DSC) from the obtained DSC curve.

The content of the styrene resin is preferably from 2 to 10 parts by mass and more preferably from 3 to 6 parts by mass to 100 parts by mass of the toner, to ensure good thermal properties.

### Colorant

The colorant has no particular limitation and can be suitably selected to suit to a particular application.

Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake,

Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone.

These can be used alone or in combination.

The proportion of the colorant is not particularly limited and can be suitably selected to suit to a particular application. The number of parts of the colorant is preferably from 1 to 15 parts by mass and more preferably from 3 to 10 parts by mass to 100 parts by mass of the toner mentioned above.

### External Additive

There is no specific limit to the selection of the external additive mentioned above and it can be suitably selected to suit to a particular application. Some examples include, but are not limited to, fine particles of metal oxides, silica oxides, and others.

Specific examples of the metal oxides include, but are not limited to, aluminum oxide, zinc oxide, cerium oxide, and zirconium oxide. These can be used alone or in combination.

Specific examples of silica oxide include, but are not limited to, silica oxide (silica), silicon carbide, silicon nitride, and silicon tetrachloride. Of these, silica oxide is preferable. These can be used alone or in combination.

Specific examples of the others include, but are not limited to, fatty acid metal salts such as zinc stearate and aluminum stearate and fluoropolymer.

### Other Components

There is no specific limit to the other components. Any component can be selected to suit to a particular application.

Some examples include, but are not limited to, a release agent, a charge control agent, a flow improver, a cleanability improver, and a magnetic material.

### Release Agent

The release agent mentioned above is not particularly limited and can be suitably selected to suit to a particular application.

Specific examples of such waxes include, but are not limited to, natural waxes including: vegetable waxes such as carnauba wax, cotton wax, Japan wax, and rice wax; animal waxes such as bee wax and lanolin; mineral waxes such as ozokerite; and petroleum waxes such as paraffin, microcrystalline, and petrolatum.

In addition to these natural waxes, synthesis hydrocarbon waxes such as Fischer-Tropsch wax and polypropylene wax and synthesis wax such as ester, ketone, and ether are also usable.

Furthermore, fatty acid amide compounds such as 12-hydroxystearic acid amide, stearic acid amide, phthalic anhydride imide, and chlorinated hydrocarbons; homopolymers or copolymers of polyacrylates, such as poly-n-stearyl methacrylate and poly-n-lauryl methacrylate (for example, a copolymer of n-stearyl acrylate and ethyl methacrylate), which are crystalline polymer resins with a low molecular weight; and crystalline polymers with a long alkyl group in the side chain can also be used.

Of these, hydrocarbon waxes such as paraffin wax, microcrystalline wax, Fischer-Tropsch wax, polyethylene wax, and polypropylene wax are preferable to reduce the occurrence of filming.

The melting point of the release agent is not particularly limited and can be suitably selected to suit to a particular application. It is preferably from 60 to 80 degrees Celsius.

A melting point of the release agent of at least 60 degrees Celsius is suitable for stable storage in a high temperature environment.

A melting point of the release agent of not higher than 80 degrees Celsius is suitable to produce high quality images.

The proportion of the release agent is not particularly limited and can be suitably selected to suit to a particular application. The number of parts of the release agent is preferably from 2 to 10 parts by mass and more preferably from 3 to 8 parts by mass to 100 parts of the toner.

### Charge Control Agent

There is no specific limitation to the selection of the charge control agent and it can be suitably selected to suit to a particular application. Specific examples include, but are not limited to, nigrosine dyes, triphenylmethane dyes, chrome containing metal complexes, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid and metal salts of salicylic acid derivatives.

Specific examples include, but are not limited to, BONTRON 03 (nigrosine dye), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are available from Orient Chemical Industries Co., Ltd.; TP-302 and TP-415 (molybdenum complex of quaternary ammonium salt), which are available from Hodogaya Chemical Co., Ltd.; LRA-901, and LR-147 (boron complex), which are available from Japan Carlit Co., Ltd.; copper phthalocyanine, perylene, quinacridone, azo pigments and polymers having a functional group such as a sulfonate group, a carboxyl group, and a quaternary ammonium group.

The proportion of the charge control agent is not particularly limited and can be suitably selected to suit to a particular application. The number of parts of the release agent is preferably from 0.1 to 10 parts by mass and more preferably from 0.2 to 5 parts by mass to 100 parts of the toner.

### Flow Improver

There is no particular limitation to the flow improver mentioned above, and it can be suitably selected for a specific application as long as it can be surface-treated to become more hydrophobic, thus maintaining fluidity and chargeability even in a highly humid environment.

Specific examples include, but are not limited to, silane coupling agents, silylating agents, silane coupling agents including an alkyl fluoride group, organic titanate coupling agents, aluminum-containing coupling agents, silicone oil, and modified silicone oil. Of silica and titanium oxide as the external additives mentioned above, silica and titanium oxide hydrophobized by surface-treating them with such a flow improver are preferable.

### Cleaning Improver

The cleaning improver is not particularly limited and can be suitably selected for a specific application, as long as it can be added to the toner to remove any residual developing agent containing the toner present on an image bearer or primary intermediate transfer medium after the transfer of an image.

Specific examples include, but are not limited to, zinc stearate, calcium stearate, and aliphatic metal salts of stearic acid, polymeric fine particles such as polymethyl methacrylate fine particles and polystyrene fine particles, which are prepared by a soap-free emulsion polymerization method. The polymeric fine particles preferably have a relatively sharp particle size distribution and the volume average particle diameter thereof is preferably from 0.01 μm to 1 μm.

### Magnetic Material

The magnetic material is not particularly limited and can be suitably selected to suit to a particular application. Specific examples include, but are not limited to iron powder, magnetite, and ferrite. Of these, white materials are preferable in terms of color tone.

### Developing Agent

The toner of the present invention may optionally contain a developing agent. The developing agent can be either a single-component developing agent or two-component developing agent. In the case of a two component developing agent, it contains the toner of the present invention and a carrier.

There is no specific limitation to the carrier and it can be suitably selected to suit to a particular application. It is preferable to use a carrier particle that has a core material and a resin layer covering the core material.

There is no specific limitation to the material for the core material and it can be suitably selected to suit to a particular application. For example, manganese-strontium (Mn—Sr) based material and manganese-magnesium (Mn—Mg) based material having 50 to 90 emu/g are preferable. To ensure the image density, highly magnetized materials such as powdered iron having 100 emu/g or more and magnetite having 75 to 120 emu/g are preferable. In addition, weakly magnetized copper-zinc (Cu—Zn) based material having 30 to 80 emu/g is preferable for reducing the impact of the contact between the toner filaments formed on the development roller and the image bearer, which is advantageous for improving the image quality.

These can be used alone or in combination.

The volume average particle diameter of the core material is preferably from 25 to 200 μm.

There is no specific limitation to the selection of the material for the resin layer mentioned above and it can be suitably selected to suit to a particular application.

Specific examples include, but are not limited to, amino-based resins, polyvinyl-based resins, polystyrene-based resins, polycarbonate-based resins, polyethylene resins, polyvinyl fluoride resins, polyvinylidene fluoride resins, polytrifluoroethylene resins, polyhexafluoropropylene resins, copolymers of vinylidene fluoride and acrylate monomer, copolymers of vinylidene fluoride and vinyl fluoride, fluoroterpolymers such as terpolymers of tetrafluoroethylene, fluorovinylidene, and monomer including no fluorine atom, and silicone resins.

These can be used alone or in combination.

In the case of a two component developing agent, the mixing ratio of the toner to the carrier (mass ratio of the toner to the carrier) is preferably 2.0 to 12.0 percent and more preferably 2.5 to 10.0 percent.

### Method of Manufacturing Toner

The method of manufacturing the toner of the present invention includes roducing base toner particles containing a polyester resin and a styrene resin, and may include other steps as necessary.

The amount of styrene resin added during the base toner particle production process is preferably between 5 to 10 parts by mass, assuming the total amount of the toner base particles is 100 parts by mass.

### Manufacturing of Base Toner Particle

One way of manufacturing the base toner particles involves mixing, kneading, pulverizing, and classifying each of the above toner materials to obtain base toner particles (colored particles) with the desired particle size. The base toner particles can be optionally mixed with other components such as inorganic fine particles (additional processes).

Specifically, to begin with, the above components are throughly mixed using a mixer such as a Henschel mixer, and then well kneaded using a continuous twin-screw extruder (e.g., Kobe Steel Ltd.'s KTK-type twin-screw extruder, Toshiba Machine Co., Ltd.'s TEM-type twin-screw extruder, Ikegai Corporation's PCM-type twin-screw extruder, or KURIMOTO, LTD.'s KEX-type twin-screw extruder) or a continuous single-screw kneader (e.g., a thermal kneader such as Buss Co.'s Co-Kneader or KCK Co.'s kneader). At this time, it is possible to use methods of increasing the specific energy such as reducing the kneading processing amount, or lowering the kneader setting temperature followed by kneading the material in a high viscosity state. The kneaded material is then subjected to coarse pulverization using a hammer mill, followed by fine pulverization using a jet mill or a mechanical pulverizer. The finely pulverized material is subsequently classified to the desired particle size using a classifier that utilizes swirling airflow or the Coanda effect. This classification can be performed, for example, by removing fine particles using a cyclone, decanter, or centrifugation. After the pulverization and classification, the pulverized material is classified in an airflow using centrifugal force or other methods to produce toner with the specified particle size.

The weight average particle diameter of the toner obtained by the method mentioned above of manufacturing the toner has no particular limit and can be suitably selected to suit to a particular application. For example, it is preferably from 4 to 10 μm and more preferably from 5 to 8 μm.

The method of measuring the weight average particle diameter is not particularly limited and may be appropriately selected depending on the intended purpose. For example, the weight average particle diameter can be measured with a particle size distribution measuring device for toner particles by a Coulter counter method.

Specific examples of the measuring device include, but are not limited to, Coulter Counter TA-II (available from Coulter Inc.) and Coulter Multisizer II (available from Coulter Inc.).

### Toner Accommodating Unit

The toner accommodating unit of the present invention contains the toner of the present invention.

The toner accommodating unit of the present invention is mounted onto an image forming apparatus. The image forming apparatus forms images with the toner of the present invention, so that the images obtained have excellent low temperature fixability and high temperature storage stability.

The toner accommodating unit of the present invention includes a unit for accommodating toner and the toner of the present invention in the unit. Some examples of the toner accommodating unit include, but are not limited to, a toner accommodating container, a developing unit, and a process cartridge.

The toner accommodating container is a vessel containing a toner.

The developing unit has a device for accommodating toner and developing with the toner.

The process cartridge of the present disclosure includes at least a latent electrostatic image bearer that bears a latent electrostatic image, a developing device that develops the latent electrostatic image borne on the latent electrostatic image bearer with the toner of the present invention to obtain a visual image, and other optional devices such as a charger, an irradiator, a transfer device, a cleaner, and a discharging device.

The developing device includes at least a developing agent container that accommodates the toner or the developing agent described above, the latent image bearer that bear and transfers the toner and the developing agent accommodated in the developing agent container with optional devices such as a layer thickness regulator that regulates the toner layer thickness borne on the latent image bearer.

The process cartridge is detachably attachable to various types of electrophotographic apparatuses, facsimile machines, printers and preferably the image forming apparatus of the present invention, which will be described later.

### Image Forming Method and Image Forming Apparatus

The image forming apparatus of the present disclosure preferably includes a latent electrostatic image bearer, a latent electrostatic image forming device for forming a latent electrostatic image on the latent electrostatic image bearer, a developing device for developing the latent electrostatic image on the latent electrostatic image bearer with the toner of the present invention to form a toner image, a transfer device for transferring the toner image onto the surface of a printing medium, and a fixing device for fixing the toner image on the surface of the printing medium. It optionally includes other devices such as a discharging (quenching) device, a cleaning device, a recycling device, and a control device.

The image forming method of the present invention preferably includes forming a latent electrostatic image on a latent electrostatic image bearer, developing the latent electrostatic image formed on the latent electrostatic image bearer with the toner of the present invention to form a toner image, transferring the toner image formed on the latent electrostatic image bearer to the surface of a printing medium, and fixing the toner image transferred to the surface of the printing medium. It may optionally include processes such as discharging (quenching), cleaning, recycling, and controlling.

### Latent Electrostatic Image Forming Step and Latent Electrostatic Image Forming Device

In the forming a latent electrostatic image, a latent electrostatic image is formed on a latent electrostatic image bearer.

The latent electrostatic image forming device forms a latent electrostatic image on the latent electrostatic image bearer.

The latent electrostatic image forming process can be suitably ececuted by the image forming device.

There is no specific limitation to the latent electrostatic image bearer (also referred to as electrophotographic photoconductor, photocondcutor, or photoreceptor) with regard to material, form, structure, size, etc. and any known latent electrostatic image bearer can be suitably selected. A latent electrostatic image bearer having a drum-like form is preferable. Also, for example, an inorganic photoconductor made of amorphous silicone or selenium and an organic photoconductor (OPC) made of polysilane or phthalopolymethine are suitable.

An example of the organic photoconductor is a layered photoconductor, including layers—a charge-generating layer formed of non-metallic materials like phthalocyanines or titanyl phthalocyanines dispersed in a binder resin and a charge-transport layer formed of charge transport materials dispersed in a binder resin—stacked on a substrate such as an aluminum drum.

Another type is a single-layer photoconductor with a single-layer structure on a substrate, featuring a photosensitive layer formed of both charge-generating and charge-transport materials dispersed in a binder resin. In the single-layer type photoconductor, it is also possible to add hole transport agents and electron transport agents as charge transport materials to the photosensitive layer.

Additionally, the option exists to include an undercoat layer between the substrate and either the charge-generating layer in the laminate photoconductor or the photosensitive layer in the single-layer photoconductor.

Latent electrostatic images are formed by, for example, uniformly charging the surface of the latent electrostatic image bearer and irradiating the surface according to the obtained image information.

The latent electrostatic image forming device preferably includes at least a charger serving as a charging device for uniformly charging the surface of the latent electrostatic image bearer and an irradiator serving as an irradiating device for irradiating the surface of the latent electrostatic image bearer with light according to the obtained image information.

Charging is accomplished, for instance, by applying a bias to the surface of the image bearer using the charging device.

The charging device (charger) is not particularly limited and can be suitably selected to suit to a particular application.

Specific examples include, but are not limited to, a known contact type charger that includes an electroconductive or semiconductive roll, brush, film, or a rubber blade, and a non-contact type charger using corona discharging such as corotron and scorotron.

Preferably, the charger is disposed in contact or non-contact with the latent electrostatic image bearer and applies a direct voltage and an alternating voltage superimposed thereon to the surface of the latent electrostatic image bearer. The charger is preferably a charging roller disposed in contact with the latent electrostatic image bearer with a gap tape therebetween. It is preferable that the charging roller apply a direct voltage on which an alternate voltage is superimposed to charge the surface of the latent electrostatic image bearer.

The irradiation is conducted by, for example, irradiating the surface of the latent electrostatic image bearer with the irradiator.

The irradiator is not particularly limited and it can be suitably selected to suit to a particular application as long as it can irradiate imagewise the surface of the latent electrostatic image bearer charged by the charger.

Specific examples of such irradiators include, but are not limited to, a photocopying optical system, a rod lens array system, a laser optical system, and a liquid crystal shutter optical system.

Embodiments of the present disclosure can employ a dorsal irradiation system, where the latent electrostatic image bearer is irradiated from the rear side in an imagewise manner.

### Developing Process and Developing Device

The developing process is to develop a latent electrostatic image formed on the latent electrostatic image bearer with the toner to form a toner image.

The developing unit is to develop a latent electrostatic image formed on the latent electrostatic image bearer with the toner to form a toner image.

The developing process can be suitably conducted by the developing device.

The toner image can be formed by, for example, developing the latent electrostatic image with the toner.

The developing device preferably includes, for example, a developing unit for accommodating the toner and provide the toner to the latent electrostatic image in a contact or non-contact manner. The developing unit preferably includes a container containing the toner.

The developing unit is either a single color developing unit or a multi-color developing unit. The developing unit suitably includes, for example, a stirrer to triboelectrically charge the toner and a rotatable magnet roller.

### Transfer Process and Transfer Device

The transfer process is to transfer the toner image formed on the latent electrostatic image bearer onto the surface of a recording medium.

The transfer device is to transfer the toner image formed on the latent electrostatic image bearer onto the surface of a recording medium.

The transfer process can be suitably conducted by the corresponding transfer device.

In the transferring process mentioned above, the toner image mentioned above is transferred to a printing medium. Preferably, the toner image is primarily transferred to an intermediate transfer member and thereafter secondarily transferred to the printing medium. It is more preferable that, with a two-color toner, preferably a full color toner, the toner image is primarily transferred to an intermediate transfer member to form a complex transfer image and the complex transfer image is thereafter secondarily transferred to the printing medium.

The transfer device (the primary transfer device and the secondary transfer device mentioned above) preferably includes a transfer unit for peeling-charge the toner image formed on the latent electrostatic image bearer or photoconductor to peel the image to the printing medium. One or more transfer devices can be provided. Specific examples of the transfer device include, but are not limited to, a corona transfer device using corona discharging, a transfer belt, a transfer belt, a transfer roller, a pressure transfer roller and an adhesive transfer device.

There is no specific limitation to the recording medium and any known recording medium (typically paper) can be suitably used.

### Fixing Process and Fixing Device

In the fixing process, the toner image transferred to the surface of a recording medium is fixed thereon.

The fixing device fixes the toner image transferred to the surface of the recording medium.

The fixing process can be suitably conducted by a corresponding fixing device.

The fixing process can be executed every time each color toner image is transferred to a recording medium. Alternatively, the fixing process can be conducted for a multi-color superimposed toner image.

There is no specific limit to the fixing device and it can be suitably selected to suit to a particular application. Using a known device that applies heating and pressure is preferable. The heating and pressing device includes, but is not limited to, a combination of a heating roller and a pressing roller or a combination of a heating roller, a pressing roller, and an endless belt can be suitably used.

### Discharging Process and Discharging Device

In the discharging process, a discharging bias is applied to the latent electrostatic image bearer.

The discharging device is to discharge the latent electrostatic image bearer by applying a discharging bias thereto.

The discharging process can be suitably conducted by the corresponding discharging device.

The discharging device is not particularly limited as long as it can apply a discharging bias to the latent electrostatic image bearer. It can be selected among the known discharging devices. One such device is a discharging lamp.

### Cleaning Process and Cleaning Device

In the cleaning process, toner remaining on the surface of the latent electrostatic image bearer is removed.

The cleaning device is to remove the toner remaining on the surface of the latent electrostatic image bearer.

The cleaning process can be suitably conducted by a corresponding cleaning device.

As the cleaning device, any known cleaner that can remove the toner remaining on the surface of the latent electrostatic image bearer is suitable. For example, a magnetic brush cleaner, an electrostatic brush cleaner, a magnetic roller cleaner, a blade cleaner, a brush cleaner, and a web cleaner are preferable.

### Recycling Process and Recycling Device

In the recycling process, the toner removed in the cleaning process mentioned above is returned to the developing device for re-use.

The recycling device is to return the toner removed by the cleaning device mentioned above to the developing device for re-use. There is no specific limitation to the recycling device and any devices including known conveying device can be used.

The recycling process can be suitably conducted by a corresponding recycling device.

### Control Process and Control Device

The control process is to control the processes described above.

The control device controls each of the aforementioned devices.

The controlling process can be suitably conducted by a corresponding controlling device.

The controlling device (controller) is not particularly limited and can be suitably selected to suit to a particular application as long as it can control the behavior of each device. Specific examples include, but are not limited to, a sequencer and a computer.

### Method of Producing Printed Matter

The method of producing printer matter of the present invention preferably forms printed matter on recording media using a latent electrostatic image bearer, a latent electrostatic image forming device for forming a latent electrostatic image on the latent electrostatic image bearer, a developing device for developing the latent electrostatic image on the latent electrostatic image bearer with toner to form a toner image, a transfer device for transferring the toner image onto the surface of a printing medium, and a fixing device for fixing the toner image on the surface of the recording medium. The method may optionally include other optional processes.

The printed matter mentioned above includes a recording medium and an image formed on the recording medium with the toner of the present invention.

Since cach process in the method of producing printed matter can use the same techniques as the aforementioned image forming method, redundant explanations are omitted.

Embodiments of the image forming device of the present invention is described with reference to the drawings. The present disclosure is not limited to these embodiments.

In each drawing, the same components may be denoted by the same reference numerals (symbols) and redundant description may be omitted. In addition, the present invention is not limited to the number, position, and shapes of the embodiments described above and those can be suitably selected to suit to implementing the present invention.

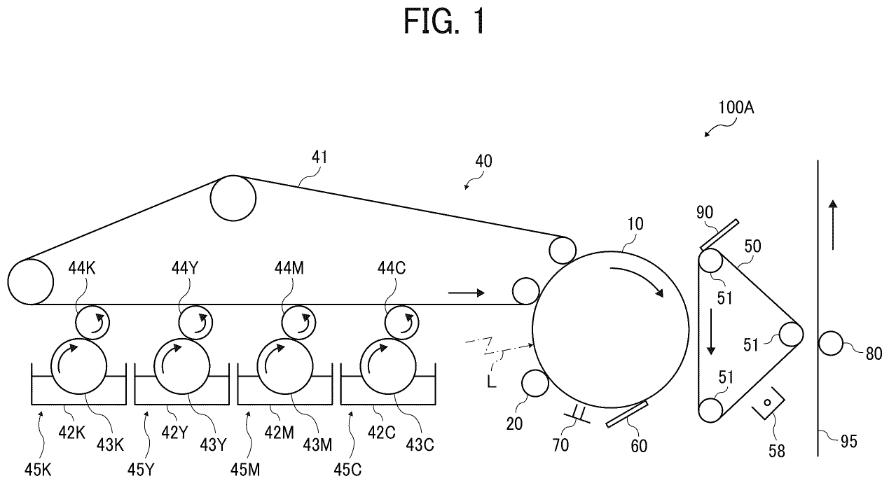

FIG. 1 is a schematic diagram illustrating an example of the image forming apparatus of the present invention.

An image forming apparatus 100A includes a drum image bearer 10, a charging roller 20, an irradiator, a developing device 40, an intermediate transfer belt 50, a cleaner 60 including a cleaning blade, and a discharging lamp 70.

The intermediate transfer belt 50 is an endless belt stretched over three rollers 51 disposed inside and moves in the direction indicated by an arrow in FIG. 1. Part of the three rollers 51 serves as a transfer bias roller to apply a transfer bias (primary transfer bias) to the intermediate transfer belt 50. Around the intermediate transfer belt 50, there is disposed a cleaner 90 including a cleaning blade. Furthermore, a transfer roller 80 capable of applying a transfer bias (secondary transfer bias) to transfer the toner image to a transfer sheet 95 is disposed facing the intermediate transfer belt 50.

In addition, around the intermediate transfer belt 50, a corona charger 58 to apply charges to the toner image transferred to the intermediate transfer belt 50 is disposed between the contact portion of the drum image bearer 10 and the intermediate transfer belt 50 and the contact portion between the intermediate transfer belt 50 and the transfer sheet 95 relative to the rotation direction of the intermediate transfer belt 50.

The developing device 40 includes a developing belt 41, a black developing unit 45K, a yellow developing unit 45Y, a magenta developing unit 45M, and a cyan developing unit 45C disposed around the developing belt 41. Each development unit 45 (45Y, 45M, 45C, and 45K) has a developing agent container 42 (42Y, 42M, 42C, and 42K), a development supplying roller 43 (43Y, 43M, 43C, and 43K), and a developing roller (developing agent bearer) 44 (44Y, 44M, 44C, and 44K). In addition, the developing belt 41 is an endless belt stretched over multiple belt rollers and moves in the direction indicated by an arrow in FIG. 1. Furthermore, the developing belt 41 is partially in contact with the drum image bearer 10.

The method of forming images using the image forming apparatus 100A is described next.

First, after uniformly charging the surface of the drum image bearer 10 using the charging roller 20, a latent electrostatic image is formed by irradiating the drum image bearer 10 with irradiation light L. Next, the latent electrostatic image formed on the drum image bearer 10 is developed with the toner supplied from the developing device 40, so that a toner image is formed. Moreover, the toner image formed on the drum image bearer 10 is (primarily) transferred to the intermediate transfer belt 50 by a transfer bias applied by the roller 51 and thereafter (secondarily) transferred to the transfer sheet 95 by a transfer bias applied by the transfer roller 80. After the toner remaining on the surface is removed by the cleaner 60, the drum image bearer 10 from which the toner image has been transferred to the intermediate transfer belt 50 is discharged by the discharging lamp 70.

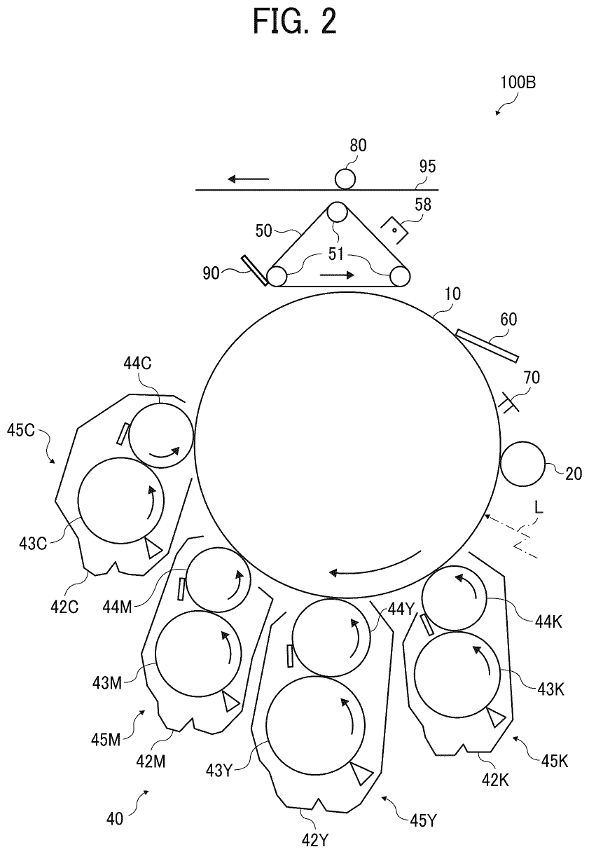

FIG. 2 is a schematic diagram illustrating another example of the image forming apparatus of the present invention.

An image forming apparatus 100B has the same configuration as the image forming apparatus 100A except that the black developing unit 45K, the yellow developing unit 45Y, the magenta developing unit 45M, and the cyan developing unit 45C are disposed around the drum image bearer 10 with no developing belt 41 provided.

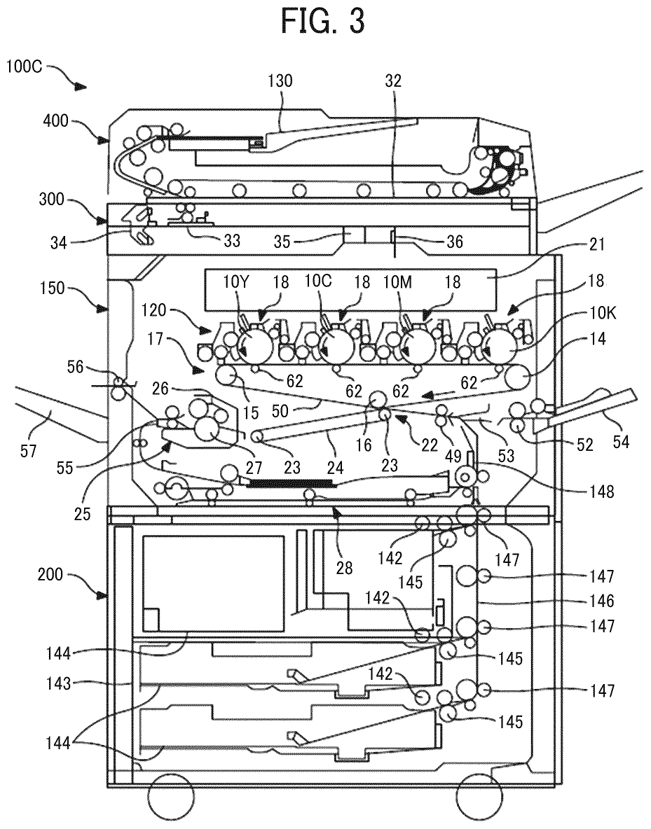

FIG. 3 is a schematic diagram illustrating another example of the image forming apparatus of the present invention;

An image forming apparatus 100C is a tandem type color image forming apparatus, including a photocopying unit 150, a sheet feeder table 200, a scanner 300, and an automatic document feeder (ADF) 400.

The intermediate transfer belt 50 disposed at the center of the photocopying unit 150 is an endless belt stretched over three rollers 14, 15, and 16 and moves in the direction indicated by an arrow in FIG. 3. Around the roller 15, a cleaner 17 is disposed including a cleaning blade to remove toner remaining on the intermediate transfer belt 50 from which the toner image has been transferred to a recording medium. Image forming units 120 for yellow, cyan, magenta and black are disposed along the conveying direction of the intermediate transfer belt 50 while facing the intermediate transfer belt 50 stretched between the rollers 14 and 15.

In addition, an irradiator 21 is disposed near the image forming unit 120. Furthermore, a secondary transfer belt 24 is disposed on the opposite side of the image forming unit 120 relative to the intermediate transfer belt 50. The secondary transfer belt 24 is an endless belt stretched over a pair of rollers 23 and the recording medium conveyed on the secondary transfer belt 24 and the intermediate transfer belt 50 can contact each other between the rollers 16 and 23.

In addition, around the secondary transfer belt 24, there are disposed a fixing belt 26 stretched over a pair of rollers and a fixing device 25 including a pressing roller 27 pressed to the fixing belt 26. Furthermore, close to the secondary transfer belt 24 and the fixing device 25, there is provided a sheet reversing device 28 to reverse the recording medium to form images on both sides of the recording medium.

A method of forming full color images using the image forming apparatus 100C is described next.

First, a color original is set on a document table 130 in the automatic document feeder (ADF) 400. Alternatively, the automatic document feeder 400 is opened to set a color original on a contact glass 32 of the scanner 300, and then the automatic document feeder 400 is closed.

When the start button is pressed, the scanner 300 is immediately driven to scan the original on the contact glass 32 with a first scanning unit 33 having a light source and a second scanning unit 34 having a mirror in the case where the original is set on the contact glass 32.

On the other hand, the scanner 300 is driven after the original is moved to the contact glass 32 in the case in which the original is set on the automatic document feeder 400. Light emitted from the first scanning unit 33 is reflected at the document and the reflected light is reflected at the second carrier 34. Thereafter, the reflected light is received at a reading sensor 36 via an image focusing lens 35 to read the document. That is, image information of black, yellow, magenta, and cyan of the document is obtained.

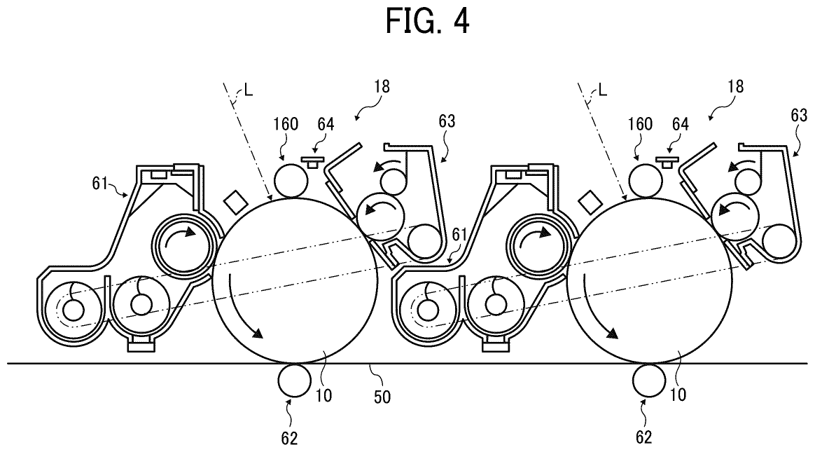

The image information of each color is transmitted to each image forming device 18 in each color image forming unit 120 and each color toner image is formed. As illustrated in FIG. 4, cach color image forming unit 120 includes a drum image bearer 10, a charging roller 160 that charges the drum image bearer 10 (10Y, 10C, 10M, and 10K), an irradiator to form cach color latent electrostatic image by irradiating the drum image bearer 10 with irradiation light L, a developing device 61 to form each color toner image by developing a latent electrostatic image with each color developing agent, a transfer roller 62 to transfer the toner image to the intermediate transfer belt 50, a cleaning device 63 having a cleaning blade, and a discharging lamp 64.

Each color toner image formed by each image forming unit 120 is sequentially and primarily transferred to and superimposed on the intermediate transfer belt 50 stretched over the roller 14, roller 15, and roller 16 to form a complex toner image.

In the sheet feeder table 200, one of the sheet feeding rollers 142 is selectively rotated to bring recording media (sheets) from one of multiple sheet cassettes 144 stacked in a sheet bank 143. A separating roller 145 separates the recording media one by one to feed it to a sheet path 146. Conveyor rollers 147 convey and guide the recording medium to a sheet path 148 in the photocopying unit 150 and the recording medium strikes at a registration roller 49 and is held there. Alternatively, a sheet feeding roller 142 is rotated to bring up the recording media (sheets) on a bypass tray 54. The printing media are separated one by one with a separating roller 52, conveyed to a manual sheet path 53, and also halted at the registration roller 49.

The registration roller 49 is generally grounded but a bias can be applied thereto to remove impurities such as paper dust on the printing medium.

The registration roller 49 is rotated in synchronization with the complex toner image (color transfer image) on the intermediate transfer belt 50 to send the recording medium (sheet) between the intermediate transfer belt 50 and the secondary transfer device 24 and secondarily transfer the complex toner image to the recording medium. The toner remaining on the intermediate transfer belt 50 from which the complex toner image has been transferred is removed by the cleaner 17.

The recording medium to which the complex toner image is transferred is conveyed by the secondary transfer belt 24. Thereafter, the fixing device 25 fixes the complex toner image on the recording medium. Thereafter, the conveyor path is switched by a switching claw 55 to eject the printing medium to an ejection tray 57 by an ejection roller 56. Alternatively, after the switching claw 55 switches the conveyor path, the recording medium is reversed by the sheet reversing device 28 and an image is formed on the reverse side of the recording medium and thereafter the recording medium is ejected to the ejection tray 57 by the ejection roller 56.

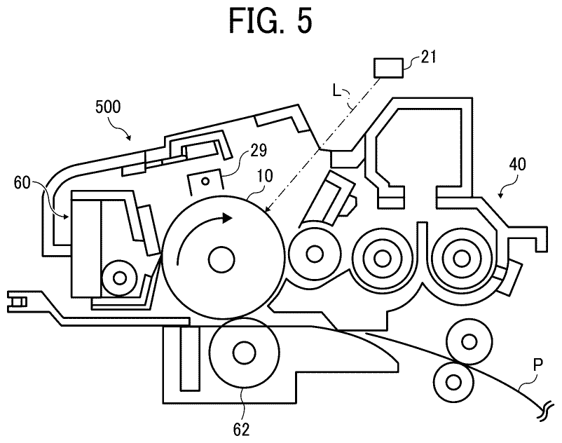

FIG. 5 is a schematic diagram illustrating an example of the process cartridge of the present embodiment. As illustrated in FIG. 5, a process cartridge 500 includes the drum image bearer 10, a corona charger 29 as a charging device, the developing device 40, the cleaner 60, and the transfer roller 62. In FIG. 5, P represents a recording medium and L represents an irradiation light.

According to the image forming apparatus and image forming method of the present invention, it is possible to provide high-quality images over a long period of time due to the toner of the present invention, which balances between the low temperature fixability and high temperature storage stability during storage, and maintains good image quality even in high temperature and high humidity environments.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

Next, the present invention is described in detail with reference to Examples and Comparative Examples but is not limited thereto. In the following Examples and Comparative Examples, “parts” represents “parts by mass” and, “percent”, “percent by mass”, unless otherwise specified.

### EXAMPLE 1

### Preparation of Toner Developing Agent 1

### Synthesis of Non-Crystalline Polyester Resin

The monomers shown in Table 1 and tetra-n-butoxytitanate as a condensation catalyst were loaded in a reaction vessel equipped with a cooling tube, a stirrer, and a nitrogen introduction tube. The mixture was allowed to react at 230 degrees Celsius for 6 hours under a nitrogen gas flow, with the generated water being removed during the process. Next, the mixture was reacted under a reduced pressure of 5 mmHg to 20 mmHg for 1 hour to obtain an amorphous polyester resin. In Table 1, “25 mol percent” for bisphenol A (2,2) propylene oxide indicates the proportion in the alcohol component in the case where the acid component is 50 mol percent and the alcohol component is 50 mol percent.

TABLE 1

| Acid component | Alcohol component | OH/COOH |
|---|---|---|
| Terephthalic acid | Bisphenol A (2,2) propylene | 1.1 |
| | oxide (25 mol percent) | |
| | Bisphenol A (2,2)ethylene | |
| | oxide (25 mol percent) | |

### Preparation of Crystalline Polyester Resin

Fumaric acid and 1,6-hexanediol were charged into a 5 L four-neck flask equipped with a nitrogen inlet tube, a dehydration tube, a stirrer, and a thermocouple, at an OH/COOH ratio of 0.9. The mixture was then reacted with titanium tetraisopropoxide (500 ppm relative to the resin components) at 180 degrees Celsius for 10 hours. Subsequently, the temperature was raised to 200 degrees Celsius and the reaction was continued for an additional 3 hours. The mixture obtained was then further reacted at a pressure of 8.3 kPa for 2 hours to obtain a crystalline polyester resin.

### Manufacturing of Base Toner Particle

The following materials were pre-mixed using a Henschel mixer (FM20B, available from Mitsui Miike Chemical Engineering Machinery Co., Ltd.), then melt-mixed at 120 degrees Celsius using a twin-screw kneader (PCM-30, available from Ikegai Corporation).
Amorphous polyester resin: 91.0 parts
Crystalline polyester resin: 4.0 parts
Styrene-α-methylstyrene copolymer (SA140, available from Kraton Corporation, Tg value of 87 degrees Celsius): 7.5 parts
Hydrocarbon wax (FNP-0090, available from Nippon Seiro Co., Ltd.): 2.5 parts
Carbon black (#44, available from Mitsubishi Chemical Corporation): 13 parts

The resulting melt-kneaded product was rolled into a thickness of 2.7 mm using rollers, then cooled to room temperature with a belt cooler and coarsely pulverized to 200 μm to 300 μm using a hammer mill. Next, the coarse powder obtained was finely pulverized using a supersonic jet mill (Lab Jet, available form Nippon Pneumatic Mfg. Co., Ltd.), and classified with an air classifier (MDS-I, available from Nippon Pneumatic Mfg. Co., Ltd.), followed by appropriately adjusting the louver opening to obtain base toner particles with a weight average particle diameter of 6.8±0.2 μm.

The styrene-a-methylstyrene copolymer (SA140, available from Kraton Corporation) has a catalogue Tg value of 87 degrees Celsius, with a variation of about±degrees Celsius depending on the production lot. Therefore, the Tg value was measured in advance using the following measurement method. The same applies to Examples and Comparative Examples below.

### Method of Measuring Tg Value

About 5.0 mg of a target sample was put in an aluminum sample container, which was then placed on a holder unit. The unit and the container were sequentially disposed in an electric furnace. Next, under a nitrogen atmosphere, the temperature was raised from-80 to 150 degrees Celsius at a temperature rising rate of 10 degrees Celsius per minute. The glass transition temperature (Tg) of the sample was then determined using the analysis program installed in the differential scanning calorimeter (DSC) from the obtained DSC curve.

### Preparation of Toner Developing Agent

One part by mass of HDK-2000 (available from Clariant AG), a metal oxide fine particle, was mixed with 100 parts by mass of the base toner particles obtained using a Henschel mixer to produce an externally added toner.

The externally added toner (5 percent by mass) was then mixed with coated ferrite carrier (95 percent by mass) using a Turbula mixer (available from Willy A. Bachofen AG) at 48 rpm for 5 minutes to produce a toner developing agent.

### Measuring of Peak Ratio

Each of the peak ratio of the obtained externally added toners were measured using the following method.
Measuring Device: Thermo Nicolet NEXUS 470 (available from Thermo SCIENTIFIC)
Resolution: 4 cm⁻¹
Number of Sample Accumulations: 16 Scans
Number of Background Accumulations: 16 Scans
Wavenumber Range Saved: 4,000 to 400 cm⁻¹

From the FT-IR spectrum obtained under the above measurement conditions, baseline correction was performed in a range of 900 cm⁻¹ to 750 cm⁻¹ to determine the maximum peak value of the polyester (829 cm⁻¹). Similarly, baseline correction was performed in a range of 800 cm⁻¹ to 600 cm⁻¹ to determine the maximum peak value of the styrene-a-methylstyrene copolymer (694 cm⁻¹). From these values, the peak ratios (R1/W1) and (R2/W2) were determined. The results are shown in Table 2.

### Evaluation on Low Temperature Fixability

The toner developing agent obtained was placed in a Ricoh photocopier (RICOH IM C5510) available from Ricoh Co., Ltd., followed by image outputting. A solid image with an amount added of 0.4 mg/cm² was output on paper (Type 6200, available from Ricoh Company, Ltd.) through the irradiation, development, and transfer processes. The fixing line speed was set to 256 mm/sec. The fixing temperature was sequentially adjusted in 2-degree C. increments, and the lowest temperature at which no cold offset occurred (fixing lower limit temperature: low-temperature fixability) was measured. Based on the evaluation criteria below, the low-temperature fixability was assessed, and the results are shown in Table 2. It is determined that a rating of B or higher is sufficient for practical use.

### Evaluation Criteria on Low Temperature Fixability

S: Lower than 120 degrees Celsius
A: 120 to lower than 125 degrees
B: 125 to lower than 130 degrees Celsius
C: 130 or higher degrees Celsius

### Evaluation on Filming

The toner developing agent obtained was placed in a photocopier available from Ricoh Co., Ltd. (RICOH IM C6010), and after conducting a continuous run of 100,000 sheets at a 1.3 percent image area coverage in a high-temperature, high-humidity environment (30 degrees Celsius, 90 percent humidity), the filming condition on the photoconductor was observed visually. Based on the evaluation criteria below, the photoconductor was evaluated regarding filming, and the results are shown in Table 2. It is determined that a rating of B or higher is sufficient for practical use.

### Evaluation Criteria of Filming

S: No toner deposits are present on the photoconductor.
A: Slight toner deposits are present on parts of the photoconductor, but there is no impact on the image.
B: Many toner deposits are present on the photoconductor, but there is no impact on the image.
C: Many toner deposits are present on the photoconductor, and image abnormalities are present.

### EXAMPLE 2

The toner developing agent of Example 2 was prepared and evaluated in the same manner as in Example 1 except for changing the styrene-a-methylstyrene copolymer (SA140, available from Kraton Corporation, Tg value of 87 degrees Celsius) from 7.5 parts to 5 parts.

### EXAMPLE 3

The toner developing agent of Example 3 was prepared and evaluated in the same manner as in Example 1 except for changing the styrene-a-methylstyrene copolymer (SA140, available from Kraton Corporation, Tg value of 87 degrees Celsius) from 7.5 parts to 10 parts.

### EXAMPLE 4

The toner developing agent of Example 4 was prepared and evaluated in the same manner as in Example 1 except for changing the wax type from hydrocarbon-based wax (FNP-0090, available from Nippon Seiro Co., Ltd.) to rice wax (TOWAX-3F16, available from TOA KASEI CO., LTD.).

### EXAMPLE 5

The toner developing agent of Example 5 was prepared and evaluated in the same manner as in Example 1 except for obtaining and using the upper Tg limit product (Tg: 90 degrees Celsius) of the styrene-α-methylstyrene copolymer (SA140, available from Kraton Corporation) used in Example 1.

### EXAMPLE 6

The toner developing agent of Example 5 was prepared and evaluated in the same manner as in Example 1 except for obtaining and using the lower Tg limit product (Tg: 81 degrees Celsius) of the styrene-α-methylstyrene copolymer (SA140, available from Kraton Corporation) used in Example 1.

### COMPARATIVE EXAMPLE 1

The toner developing agent of Comparative Example 1 was prepared and evaluated in the same manner as in Example 1 except for changing the styrene-α-methylstyrene copolymer (SA140, available from Kraton Corporation) from 7.5 parts to 4.5 parts.

### COMPARATIVE EXAMPLE 2

The toner developing agent of Comparative Example 2 was prepared and evaluated in the same manner as in Example 1 except for changing the styrene-α-methylstyrene copolymer (SA140, available from Kraton Corporation) from 7.5 parts to 10.5 parts.

TABLE 2

| | | | Low temperature | |
|---|---|---|---|---|
| | R1/W1 | R2/W2 | fixability | Filming |
| Example 1 | 1.40 | 1.00 | S | S |
| Example 2 | 1.01 | 0.83 | S | B |
| Example 3 | 1.97 | 1.19 | B | S |
| Example 4 | 1.38 | 0.99 | S | A |
| Example 5 | 1.46 | 1.02 | B | S |
| Example 6 | 1.38 | 1.01 | S | A |
| Comparative | 0.89 | 0.72 | S | C |
| Example 1 | | | | |
| Comparative | 2.22 | 1.23 | C | S |
| Example 2 | | | | |

Aspects of the present disclosure include, but are not limited to the following:

### Aspect 1

A toner contains a polyester resin and a styrene resin, wherein the peak ratio (R1/W1) is between 1.00 and 2.00, where R1 represents the maximum peak height in a range of 710 cm⁻¹ to 690 cm⁻¹ of a Fourier Transform Infrared Spectroscopy (FT-IR) spectrum of the toner measured by Attenuated Total Reflection (ATR) method and W1 represents the maximum peak height in a range of 789 cm⁻¹ to 852 cm⁻¹ of the FT-IR spectrum of the toner measured by ATR method, and the peak ratio (R2/W2) is between 0.80 and 1.20, where R2 represents the maximum peak height in a range of 710 cm⁻¹ to 690 cm⁻¹ of an FT-IR spectrum of the toner measured by KBr tablet method and W2 represents the maximum peak height in a range of 789 cm⁻¹ to 852 cm⁻¹ of the FT-IR spectrum of the toner measured by KBr tablet method.

### Aspect 2

The toner according to Aspect 1 mentioned above further contains a hydrocarbon wax.

### Aspect 3

The toner according to Aspect 1 or 2 mentioned above, wherein the styrene resin has a glass transition temperature of 80 to 90 degrees Celsius.

### Aspect 4

An ink container containing the toner of any one of Aspects 1 to 3 mentioned above.

### Aspect 5

An image forming apparatus includes a latent electrostatic image bearer, a latent electrostatic image forming device to form a latent electrostatic image on the latent electrostatic image bearer, a developing device to develop the latent electrostatic image on the latent electrostatic image bearer with the toner of any one of Aspects 1 to 3 to form a toner image, a transfer device to transfer the toner image on the latent electrostatic image bearer onto a surface of a recording medium, and a fixing device to fix the toner image on the surface of the recording medium.

### Aspect 6

An image forming method includes forming a latent electrostatic image on a latent electrostatic image bearer, developing the latent electrostatic image formed on the latent electrostatic image bearer with the toner of any one of Aspects 1 to 3 to form a toner image, transferring the toner image formed on the latent electrostatic image bearer to a surface of a recording medium, and fixing the toner image on the surface of the recording medium.

### Aspect 7

forming a latent electrostatic image on a latent electrostatic image bearer;
developing the latent electrostatic image on the latent electrostatic image bearer with the toner of claim 1 to form a toner image;
transferring the toner image onto a surface of the recording medium; and
fixing the toner image on the surface of the recording medium to produce the printed matter.

### Aspect 8

A method of manufacturing a toner of any one of Aspects 1 to 3 includes manufacturing a base toner particle containing the polyester resin and the styrene resin, wherein the proportion of the styrene resin in the manufacturing the base toner particle is from 5 to 10 parts by mass to the entire amount of 100 parts by mass of the base toner particle.

1. A toner comprising:
a polyester resin; and
a styrene resin,
wherein a peak ratio (R1/W1) is between 1.00 and 2.00, where R1 represents a maximum peak height method in a range of 710 cm⁻¹ to 690 cm⁻¹ of a Fourier Transform Infrared Spectroscopy (FT-IR) spectrum of the toner measured by Attenuated Total Reflection (ATR), and W1 represents a maximum peak height in a range of 789 cm⁻¹ to 852 cm⁻¹ of the FT-IR spectrum of the toner measured by ATR method, and
a peak ratio (R2/W2) is between 0.80 and 1.20, where R2 represents a maximum peak height method in a range of 710 cm⁻¹ to 690 cm⁻¹ of an FT-IR spectrum of the toner measured by KBr tablet method, and W2 represents a maximum peak height in a range of 789 cm⁻¹ to 852 cm⁻¹ of the FT-IR spectrum of the toner measured by KBr tablet method.

2. The toner according to claim 1, further comprising a hydrocarbon wax.

3. The toner according to claim 1, wherein the styrene resin has a glass transition temperature of 80 to 90 degrees Celsius.

4. A toner accommodating unit containing the toner of claim 1.

5. An image forming apparatus comprising:
a latent electrostatic image bearer;
a latent electrostatic image forming device to form a latent electrostatic image on the latent electrostatic image bearer;
a developing device to develop the latent electrostatic image on the latent electrostatic image bearer with the toner of claim 1 to form a toner image;
a transfer device to transfer the toner image on the latent electrostatic image bearer onto a surface of a recording medium; and
a fixing device to fix the toner image on the surface of the recording medium.

6. An image forming method comprising:
forming a latent electrostatic image on a latent electrostatic image bearer;
developing the latent electrostatic image formed on the latent electrostatic image bearer with the toner of claim 1 to form a toner image;
transferring the toner image formed on the latent electrostatic image bearer to a surface of a recording medium; and
fixing the toner image on the surface of the recording medium.

7. A method of producing printed matter comprising:
forming a latent electrostatic image on a latent electrostatic image bearer;
developing the latent electrostatic image on the latent electrostatic image bearer with the toner of claim 1 to form a toner image;
transferring the toner image onto a surface of the recording medium; and
fixing the toner image on the surface of the recording medium to produce the printed matter.

8. A method of manufacturing a toner of claim 1 comprising:
manufacturing a base toner particle comprising:
the polyester resin; and
the styrene resin,
wherein a proportion of the styrene resin in the manufacturing the base toner particle is from 5 to 10 parts by mass to an entire amount of 100 parts by mass of the base toner particle.
